(19) United States
(12) Patent Application Publication
(10) Pub. No.: US 2007/0206681 A1
(43) Pub. Date: Sep. 6, 2007

(54) Mode decision for intra video encoding

(76) Inventors: Jun Xin, Quincy, MA (US); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/367,054

(22) Filed: Mar. 2, 2006

(51) Int. Cl. H04N 11/04; H04N 7/12

(52) U.S. Cl. 375/240.24; 375/240.26

(57) ABSTRACT

A method and system for selecting modes for encoding macroblocks in a sequence of frames of a video is presented. For each current macroblock in each frame, an amount of correlation with a previous corresponding reference macroblock encoded according to an encoding mode associated with the corresponding reference macroblock is measured. Then, the encoding mode associated with the corresponding reference macroblock is selected as the mode for encoding the current macroblock if the amount of correlation is greater than a predetermined threshold, and otherwise a new mode a new mode is selected.

### FIELD OF THE INVENTION

The invention relates generally to intra video encoding, and more particularly to the mode decision for intra video encoding.

### BACKGROUND OF THE INVENTION

Intra-only video encoding is a widely used encoding method in professional and surveillance video applications partly due to its ease of editing. The H.264/AVC video compression standard, see ITU-T Rec. H.264|ISO/IEC 14496-10, “Advanced Video Coding,” 2003, incorporated herein by reference, has demonstrated excellent encoding efficiency using intra-only encoding compared to state of the art still image encoding schemes such as JPEG 2000, see ISO/IEC 15444-1, “Information technology—JPEG 2000 image coding system—Part 1: Core coding system,” 2000.

To support such applications in an interoperable way, the Joint Video Team (JVT), which is comprised of video coding experts from both ISO and ITU-T, is currently working on a standardized specification of an intra-only 4:4:4 profile, see Yu and Liu, “Advanced 4:4:4 Profile for MPEG4-Part10/H.264,” JVT-P017, July 2005, incorporated herein by reference.

FIG. 1 shows a basic encoding process of such a standard prior art intra-only video encoder. Each frame 101 of an input video is partitioned into macroblocks 102. As defined herein, corresponding macroblocks 102 and 103 are spatially collocated in different frames 101 and 104.

Each macroblock is subject to a transform/scaling 110 and entropy encoding 120 to produce an output bitstream 121. The output of the transform/scaling is subjected to an inverse scaling and transform 130. An encoding mode decision 140 is made considering the content of a pixel buffer 150 and the candidate set of prediction modes. The encoding mode decision produces a selected encoding mode 141. Then, the result (intra prediction) 160 of the decision is subtracted 170 from the input signal to produce an error signal. The result of the prediction is also added 180 to the output of the inverse scaling and transform 130 and stored into the pixel buffer 150.

In general, each frame of the input video is partitioned spatially into macroblocks, where each macroblock includes smaller-sized blocks. The macroblock is the basic unit of encoding, while the blocks typically correspond to the dimension of the transform.

The notion of a macroblock partition is often used to refer to the group of pixels in a macroblock that share a common prediction. The dimensions of a macroblock, block and macroblock partition are not necessarily equal. An allowable set of macroblock partitions typically vary from one encoding scheme to another. For example, in an I-slice of H.264/AVC, a 16×16 macroblock may be encoded as a 16×16 block or a mix of 8×8 and 4×4 macroblock partitions. Prediction can then be performed independently for each macroblock partition. The encoding is based on 4×4 blocks when intra_{—}16×16 and intra_{—}4×4 are used. The encoding is based on 8×8 blocks when intra_{—}8×8 is used.

The encoder selects the encoding modes for the macroblock, including the best macroblock partition and mode of prediction for each macroblock partition, such that the video encoding performance is optimized. The selection process is conventionally referred to as ‘macroblock mode decision’.

For intra-only video encoding, the macroblock is encoded as an intra-macroblock, which uses information from only the current frame. According to the H.264/AVC specification, the prediction process for intra coded macroblocks is defined by forming spatial prediction signals from previously decoded pixels in macroblocks to the left and/or above the current macroblock. Given all the available set of candidate prediction modes, the mode decision process selects an encoding mode for each macroblock.

In the H.264/AVC video coding standard there are many available modes for encoding a macroblock. The available encoding modes for a macroblock in an I-slice include: intra_{—}4×4 prediction, intra_{—}8×8 prediction and intra_{—}16×16 prediction for luma samples, and intra_{—}8×8 prediction for chroma samples. Depending on the block size for prediction and whether the prediction is for luma or chroma samples, there are a number of prediction modes.

If using intra_{—}4×4 prediction (luma only), each 4×4 macroblock partition can be encoded using one of the nine prediction modes defined by the H.264/AVC standard. If using intra_{—}16×16 prediction (luma only), the 16×16 macroblock can be predicted using one of four prediction modes. If using intra_{—}8×8 predictions for luma, each 8×8 macroblock partition can be encoded using one of the nine prediction modes. If using intra_{—}8×8 predictions for chroma, each 8×8 macroblock partition can be encoded using one of four prediction modes. Every macroblock encoding mode provides a different rate-distortion (RD) trade-off.

It is an object of the invention to select the macroblock encoding mode that optimizes the performance with respect to both rate (R) and distortion (D).

Typically, the rate-distortion optimization uses a Lagrange multiplier to make the macroblock mode decision. The rate-distortion optimization evaluates a Lagrange cost for each candidate encoding mode for a macroblock and selects the mode with a minimum Lagrange cost.

If there are N candidate modes for encoding a macroblock, then the Lagrange cost of the n^{th} candidate mode Jₙ is the sum of the Lagrange cost of the macroblock partitions:

$${J}_{n} = {\sum }_{i = 1}^{{P}_{n}} {J}_{n , i} n = 1 , 2 , … , N \qquad ( 1 )$$

where Pₙ is the number of macroblock partitions of the nth candidate mode. A macroblock partition can be of a different size depending on the prediction mode. For example, the partition size is 4×4 for the intra_{—}4×4 prediction and 16×16 for the intra_{—}16×16 prediction.

If the number of candidate encoding modes for the i^{th} partition of the n^{th} macroblock is K_{n, i}, then the cost of this macroblock partition is

$$\begin{matrix}{J}_{n , i} = {min}_{k = 1 , 2 , … , {K}_{n , i}} ( {J}_{n , i , k} ) \\ = {min}_{k = 1 , 2 , … , {K}_{n , i}} ( {D}_{n , i , k} + λ \times {R}_{n , i , k} )\end{matrix} \qquad ( 2 )$$

where R and D are respectively the rate and distortion, and λ is the Lagrange multiplier. The Lagrange multiplier controls the rate-distortion tradeoff of the macroblock encoding, and can be derived from a quantization parameter.

The above equation states that the Lagrange cost of the i^{th} partition of the n^{th} macroblock, J_{n, i},is selected to be the minimum of the K_{n, i} costs that are yielded by the candidate encoding modes for this partition. Therefore, the optimal encoding mode of this partition is the one that yields J_{n, i}. The optimal encoding mode for the macroblock is selected to be the candidate mode that yields the minimum cost, i.e.,

$${J}^{*} = {min}_{n = 1 , 2 , … , N} {J}_{n} . \qquad ( 3 )$$

FIG. 2 shows a conventional process for determining the Lagrange cost for a encoding mode of a macroblock partition, i.e., J_{n, i, k}. A difference 210 between the input macroblock partition 211 and its prediction 212 is subjected to a transform/scaling 220, and then the rate is determined 230. The resulting coefficients are also subject to inverse scaling and transform 240, and prediction compensation using the intra prediction 271, pixel buffer 272 and candidate prediction modes 273, to reconstruct the macroblock partition. The distortion (D) 251 is then determined 250 between the reconstructed and the input macroblock partition. In the end, the Lagrange cost 261 is determined 260 using the rate and distortion. Then, the optimal encoding mode 262 corresponds to the mode with the minimum cost.

This process for determining the Lagrange cost needs to be performed many times because there are a large number of available modes for encoding a macroblock according to the H.264/AVC standard. Therefore, the computation of the rate-distortion optimized encoding mode decision can be complex and time consuming.

Consequently, there is a need to perform efficient rate-distortion optimized macroblock mode decision in H.264/AVC video encoding.

There are several prior art methods that specifically aim to reduce the complexity of the intra mode decision process. However, none of the prior art methods provide significant reductions in complexity with quality that is close to the optimal.

One method reduces the number of candidate modes 273 based on pre-analysis of the input macroblock data, see for example, Pan et al., “Fast Mode Decision for Intra Prediction,” JVT-G013, March 2003; Meng et al., “Efficient Intra-Prediction Mode Selection for 4×4 Blocks in H.264,” Proc. IEEE International Conference on Multimedia and Expo, July 2003; Zhang et al., “Fast 4×4 Intra-prediction Mode Selection for H.264,” Proc. IEEE International Conference on Multimedia and Expo, June 2004; and Pan et al., “A Directional Field Based Fast Intra Mode Decision Algorithm for H.264 Video Encoding,” IEEE International Conference on Multimedia and Expo, June 2004.

An alternative method reduces the complexity by modifying the mode decision architecture and computing distortion in the transform-domain as described by Xin et al. in U.S. patent application Ser. No. 10/858,162, “Selecting Macroblock Coding Modes for Video Encoding” filed Jun. 1, 2004.

### SUMMARY OF THE INVENTION

The embodiments of the invention provide a method for performing mode decision for a current macroblock that exploits the correlation between mode decisions of temporally adjacent frames. Using this method, reduced computation is achieved with minimal loss in quality.

### BRIEF DESCRIPTION OF THE DRAWINGS

FIG. 1 is a block diagram of a prior art video encoding system including mode decision;

FIG. 2 is a block diagram of a prior art optimal mode decision;

FIG. 3 is a block diagram of a near-optimal mode decision according to an embodiment of the invention;

FIG. 4 is a block diagram of pixels used to measure correlation according to an embodiment of the invention; and

FIG. 5 is block diagram of buffer update within the near-optimal mode decision according to an embodiment of the invention.

### DETAILED DESCRIPTION OF THE PREFERRED EMBODIMENT

Our invention provides a system and method for determining an encoding mode for intra-only video encoding that is near optimal in a rate-distortion sense.

Method and System Overview

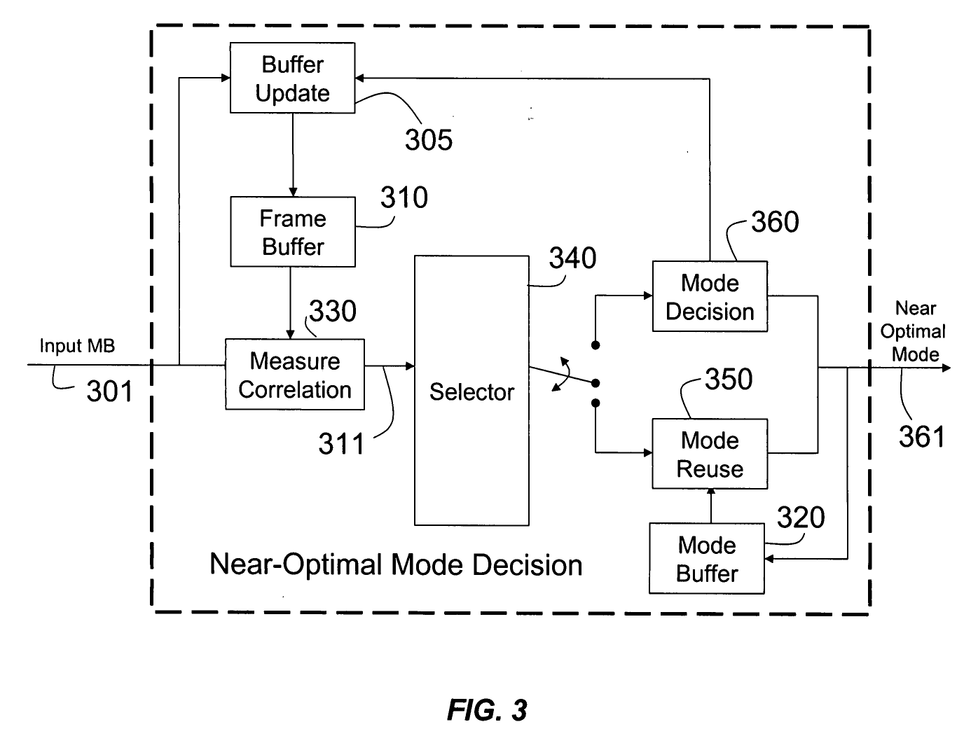

FIG. 3 shows a method and system according to an embodiment of the invention for selecting, for each macroblock in a sequence of intra-frames or video, a near optimal encoding mode from multiple available candidate encoding modes.

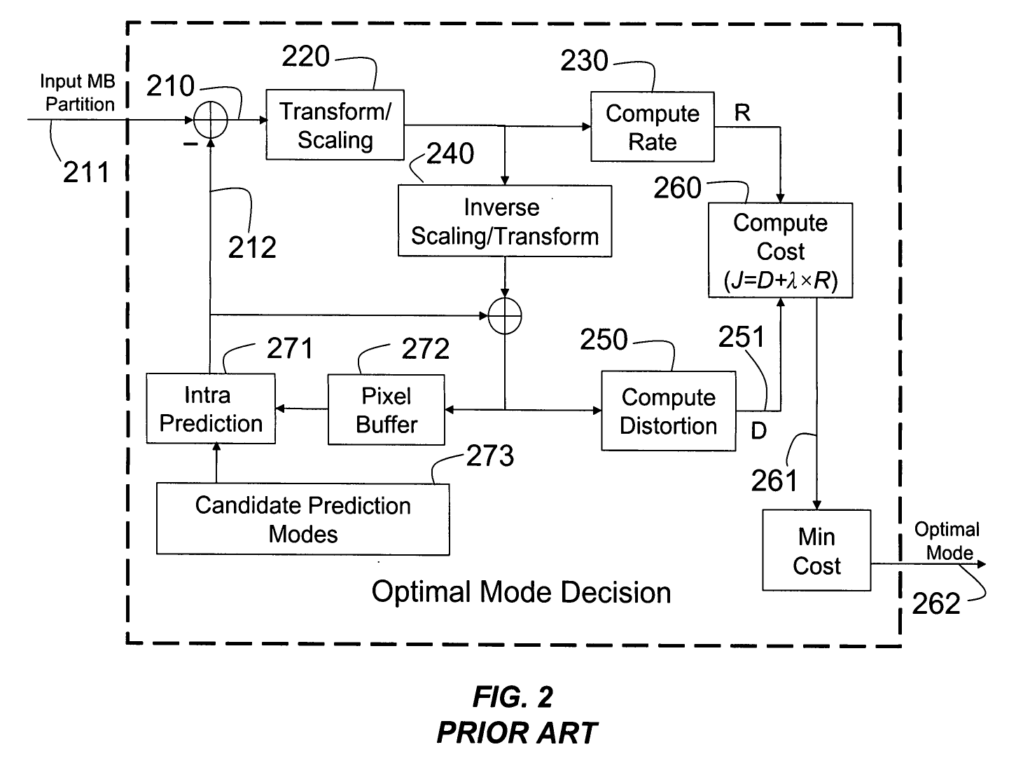

The first frame of a video is subject to a conventional mode decision process to yield an initial set of modes. Each macroblock is associated with one encoding mode. We use the optimal encoding mode decision as described for FIG. 2 for this purpose. During this initial step, the macroblocks of the first (reference) frame are stored in a frame buffer 310 and the set of modes is stored in a mode buffer 320.

For each successive intra-frame, each input macroblock (MB) 301 is first compared to the corresponding (collocated) reference macroblock that is stored in the frame buffer 310 to measure 330 an amount of correlation 331. The amount of correlation is passed on to a selector 340. Details of the correlation metric are described below.

If the amount of correlation is greater than a predetermined threshold, then the selector 340 reuses 350 the encoding mode of the corresponding collocated macroblock in a previous frame, which is stored in the mode buffer 320. The selected mode is reused to encode the current macroblock. Otherwise, the selector determines 360 a new mode for the current input macroblock using a conventional or optimal mode decision process.

The predetermined threshold is used to control the tradeoff between the quality and complexity. A relatively larger threshold leads to lower quality, but faster mode decisions, and hence, lower computational complexity.

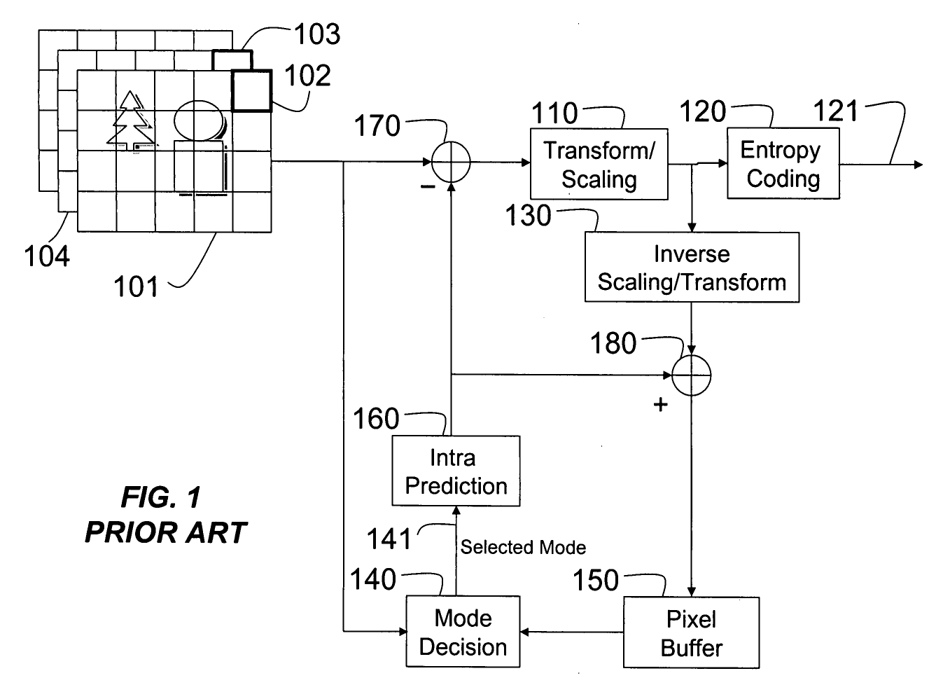

The output of the above process is a near-optimal mode 361, which is then used as the selected mode 141 for encoding as described for FIG. 1.

The near-optimal modes for all macroblocks of the current frame are stored in the mode buffer 320. For macroblocks with low correlation, i.e., those that were subject to a new macroblock mode decision, the frame buffer is updated 305 with pixels of the current input macroblock. It is noted that only macroblock data corresponding to new mode decisions are updated to the buffer. Further details about the buffer updating are described below.

Measuring Correlation

To measure the amount of correlation between two macroblocks for the purpose of reusing 350 a mode decision, we define a difference measure between two macroblocks, b₂ and b₁ as:

$$D ( {b}_{2} , {b}_{1} ) = - ( \begin{matrix}{\sum }_{j = {b}_{y} - 1}^{{b}_{y} + 15} {\sum }_{i = {b}_{x} - 1}^{{b}_{x} + 15} \vert {p}_{2} ( j , i ) - {p}_{1} ( j , i ) \vert + \\ {\sum }_{i = {b}_{x} + 16}^{{b}_{x} + 23} \vert {p}_{2} ( {b}_{y} - 1 , i ) - {p}_{1} ( {b}_{y} - 1 , i ) \vert\end{matrix} ) . \qquad ( 4 )$$

In the above equation, p₂ and p₁ are the two frames containing b₂ and b₁, and b_{y} and bₓ are the vertical and horizontal coordinates of b₂ and b₁, respectively. This difference measure includes all pixels that could be used for intra prediction for the current macroblock. Specifically, the difference measure includes the contributions from not only the pixels of the collocated macroblock, but also its spatial neighbors that may be used for intra predictions.

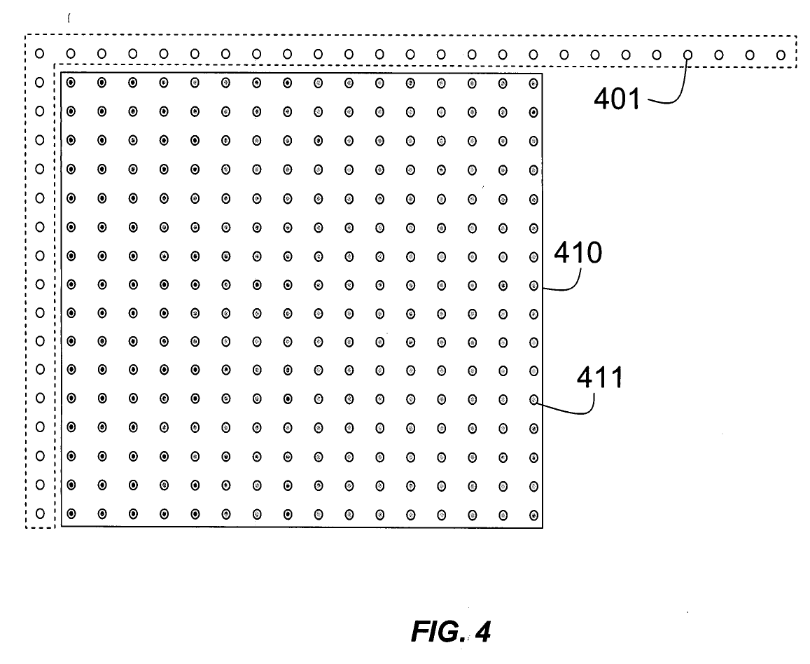

FIG. 4 shows adjacent neighboring pixels 401 that may be used to predict the current macroblock 410, including the pixels 411 for the current macroblock (filled circles) and its adjacent spatial neighboring pixels necessary for intra prediction (open circles) 401.

Updating Buffer

As described above, the frame buffer 310 is updated 305 with pixels of the current input macroblock only when there is a new mode decision. This strategy allows for correlations 311 to be measured 330 based on the original macroblock that was used to determine a particular encoding mode. If the differences were taken with respect to the immediately previous frame, then it would become possible that small differences, i.e., less than the threshold, over time would not be detected. In that case, an encoding mode would continue to be reused even though the macroblock characteristics over time may have changed significantly.

To overcome this issue, decisions to reuse a macroblock encoding mode are always based on the original macroblock that was used to determine a particular encoding mode.

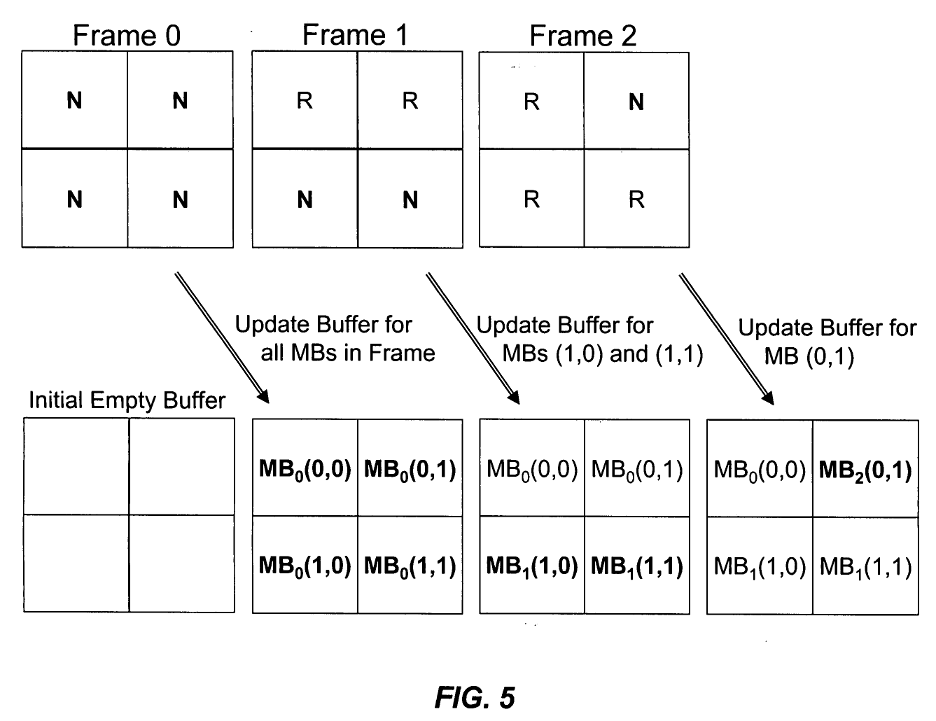

FIG. 5 shows the buffer updating process for several frames containing four macroblocks each.

For Frame 0, the mode decisions for all four macroblocks are newly determined and denoted with an N. The macroblock data from Frame 0 {MB₀(0, 0), MB₀(0, 1), MB₀(1, 0), MB₀(l, 1)} are then stored in the frame buffer. For Frame 1, the mode decision has determined that the encoding modes for macroblocks (0, 0) and (0, 1) will be reused, which are denoted with an R, while the encoding modes for macroblocks (1, 0) and (1, 1) are newly determined and denoted with an N. As a result, the buffer is updated with the corresponding macroblock data from Frame 1 {MB₁(1, 0), MB₁(1, 1)} while the data for other macroblocks remain unchanged. For Frame 2, only macroblock (0, 1) has been newly determined, therefore the only update to the frame buffer is {MB₂(0, 1)}.

It is evident from the above example that the frame buffer 310 is composed of a mix of macroblock data from different frames. The source of the data for each macroblock represents the frame at which the encoding mode decision was determined. The data in the frame buffer are used as a reference to determine whether the current input macroblock is sufficiently correlated and whether the macroblock encoding mode could be reused.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for selecting modes for encoding macroblocks in a sequence of frames of a video, comprising the steps of:
measuring, for each current macroblock in each intra-frame, an amount of correlation with a previous corresponding reference macroblock encoded according to an encoding mode associated with the corresponding reference macroblock; and
selecting the encoding mode associated with the corresponding reference macroblock as the mode for encoding the current macroblock if the amount of correlation is greater than a predetermined threshold, and otherwise selecting a new mode.

2. The method of claim 1, in which the new mode is selected using a conventional mode decision process.

3. The method of claim 1, in which the new mode is selected using an optimal mode decision process.

4. The method of claim 1, further comprising:
encoding the current macroblock according the selected mode.

5. The method of claim 4, in which a relatively smaller predetermined threshold leads to lower quality and faster mode decision for the current macroblock.

6. The method of claim 1, in which a first frame is subject to a conventional mode decision process to yield an initial set of modes for the macroblock in the first frame.

7. The method of claim 6, further comprising:
storing the set of modes in a mode buffer; and
storing each new mode in the mode buffer.

8. The method of claim 1, further comprising:
storing the current macroblock in a frame buffer only if the new mode is selected.

9. The method of claim 1, in which the amount of correlation is a difference measure D between the current macroblock b₂ and the previous corresponding reference macroblock b₁:
$$D ( {b}_{2} , {b}_{1} ) = - ( {\sum }_{j = {b}_{y} - 1}^{{b}_{y} + 15} {\sum }_{i = {b}_{x} - 1}^{{b}_{x} + 15} \vert {p}_{2} ( j , i ) - {p}_{1} ( j , i ) \vert + {\sum }_{i = {b}_{x} + 16}^{{b}_{x} + 23} \vert {p}_{2} ( {b}_{y} - 1 , i ) - {p}_{1} ( {b}_{y} - 1 , i ) \vert )$$
where p₂ and p₁ are frames containing the macroblocks b₂ and b₁,b_{y} and bₓ are vertical and horizontal coordinates of the macroblocks b₂ and b₁, and i and j are indices.

10. The method of claim 1, in which the difference measure includes all pixels used for intra prediction for the current macroblock and spatial neighboring pixels used for intra prediction.

11. A system for selecting a mode for encoding macroblocks in a sequence of frames of a video, comprising:
means for measuring, for a current macroblock in each frame, an amount of correlation with a previous corresponding reference macroblock encoded according to an encoding mode associated with the corresponding reference macroblock; and
a selector configured to select the encoding mode associated with the corresponding reference macroblock as the mode for encoding the current macroblock if the amount of correlation is greater than a predetermined threshold, and otherwise selecting a new mode.
